(19) United States
(12) Patent Application Publication
(10) Pub. No.: US 2023/0300729 A1
(43) Pub. Date: Sep. 21, 2023

(54) USER EQUIPMENT RADIO CAPABILITIES

(71) Applicant: Lenovo (Singapore) Pte. Ltd., New Tech Park (SG)

(72) Inventors: Genadi Velev, Darmstadt (DE); Joachim Loehr, Wiesbaden (DE); Prateek Basu Mallick, Dreieich (DE); Ravi Kuchibhotla, Chicago, IL (US); Hyung-Nam Choi, Ottobrunn (DE)

(21) Appl. No.: 18/016,606

(22) PCT Filed: Jul. 14, 2021
(86) PCT No.: PCT/IB2021/056374

§ 371 Date: Jan. 17, 2023

Related U.S. Application Data
(60) Provisional application No. 63/052,210, filed on Jul. 15, 2020.

(51) Int. Cl. H04W 48/18; H04W 60/00

(52) U.S. Cl. CPC H04W 48/18; H04W 60/00

(57) ABSTRACT

Apparatuses, methods, and systems are disclosed for user equipment radio capabilities. One method includes transmitting, from a core network function, a request for radio capabilities of a user equipment. The method includes receiving a response to the request for the radio capabilities of the user equipment. The method includes determining at least one allowed network slice, at least one rejected network slice, or a combination thereof based on the radio capabilities of the user equipment. The method includes transmitting a configuration message to the user equipment, wherein the configuration message indicates the at least one allowed network slice, the at least one rejected network slice, or the combination thereof.

### CROSS-REFERENCE TO RELATED APPLICATIONS

This application claims priority to U.S. Patent Application Ser. No. 63/052,210 entitled “APPARATUSES, METHODS, AND SYSTEMS FOR USING NETWORK SLICES DEPLOYED IN SPECIFIC FREQUENCY BANDS” and filed on Jul. 15, 2020 for Genadi Velev, which is incorporated herein by reference in its entirety.

### FIELD

The subject matter disclosed herein relates generally to wireless communications and more particularly relates to user equipment radio capabilities.

### BACKGROUND

In certain wireless communications networks, certain network slices may be allowed, while other network slices may not be allowed. A network may need to determine which network slices to allow.

### BRIEF SUMMARY

Methods for user equipment radio capabilities are disclosed. Apparatuses and systems also perform the functions of the methods. One embodiment of a method includes transmitting, from a core network function, a request for radio capabilities of a user equipment. In some embodiments, the method includes receiving a response to the request for the radio capabilities of the user equipment. In certain embodiments, the method includes determining at least one allowed network slice, at least one rejected network slice, or a combination thereof based on the radio capabilities of the user equipment. In various embodiments, the method includes transmitting a configuration message to the user equipment, wherein the configuration message indicates the at least one allowed network slice, the at least one rejected network slice, or the combination thereof.

One apparatus for user equipment radio capabilities includes a core network function. In some embodiments, the apparatus includes a transmitter that transmits a request for radio capabilities of a user equipment. In various embodiments, the apparatus includes a receiver that receives a response to the request for the radio capabilities of the user equipment. In certain embodiments, the apparatus includes a processor that determines at least one allowed network slice, at least one rejected network slice, or a combination thereof based on the radio capabilities of the user equipment. In some embodiments, the transmitter transmits a configuration message to the user equipment, and the configuration message indicates the at least one allowed network slice, the at least one rejected network slice, or the combination thereof.

Another embodiment of a method for user equipment radio capabilities includes receiving, from a core network function, a request for radio capabilities of a user equipment. In some embodiments, the method includes determining the radio capabilities of the user equipment. In certain embodiments, the method includes transmitting a response to the request for the radio capabilities of the user equipment.

Another apparatus for user equipment radio capabilities includes a user equipment. In some embodiments, the apparatus includes a receiver that receives, from a core network function, a request for radio capabilities of the user equipment. In various embodiments, the apparatus includes a processor that determines the radio capabilities of the user equipment. In certain embodiments, the apparatus includes a transmitter that transmits a response to the request for the radio capabilities of the user equipment.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for user equipment radio capabilities;

FIG. 2 is a schematic block diagram illustrating one embodiment of an apparatus that may be used for user equipment radio capabilities;

FIG. 3 is a schematic block diagram illustrating one embodiment of an apparatus that may be used for user equipment radio capabilities;

FIG. 4 is a network communications diagram illustrating one embodiment of a system for determining allowed NSSAI based on UE radio capabilities;

FIG. 5 is a flow chart diagram illustrating one embodiment of a method for user equipment radio capabilities; and

FIG. 6 is a flow chart diagram illustrating another embodiment of a method for user equipment radio capabilities.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

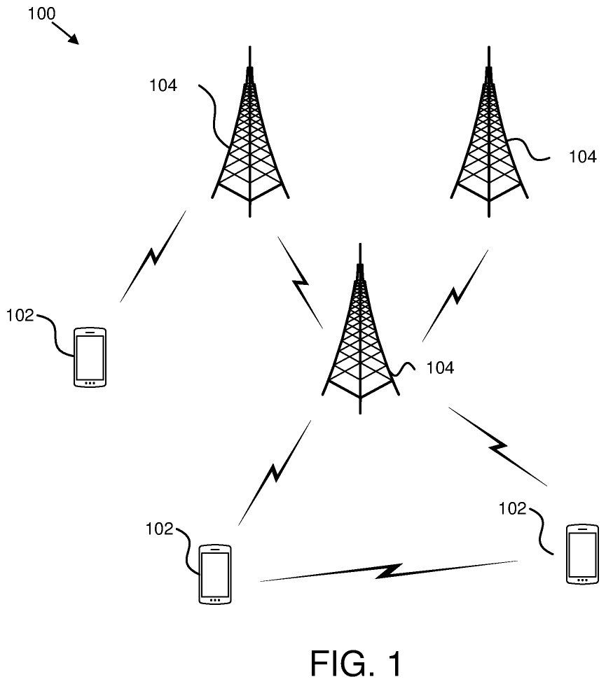

FIG. 1 depicts an embodiment of a wireless communication system 100 for user equipment radio capabilities. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may transmit, from a core network function, a request for radio capabilities of a user equipment. In some embodiments, the network unit 104 may receive a response to the request for the radio capabilities of the user equipment. In certain embodiments, the network unit 104 may determine at least one allowed network slice, at least one rejected network slice, or a combination thereof based on the radio capabilities of the user equipment. In various embodiments, the network unit 104 may transmit a configuration message to the user equipment, wherein the configuration message indicates the at least one allowed network slice, the at least one rejected network slice, or the combination thereof. Accordingly, the network unit 104 may be used for user equipment radio capabilities.

In certain embodiments, a remote unit 102 may receive, from a core network function, a request for radio capabilities of a user equipment. In some embodiments, the remote unit 102 may determine the radio capabilities of the user equipment. In certain embodiments, the remote unit 102 may transmit a response to the request for the radio capabilities of the user equipment. Accordingly, the remote unit 102 may be used for user equipment radio capabilities.

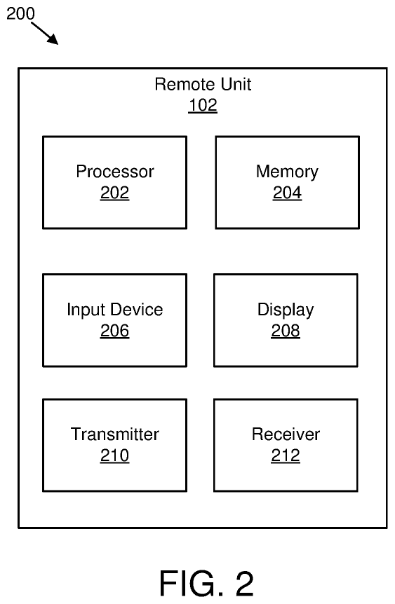

FIG. 2 depicts one embodiment of an apparatus 200 that may be used for user equipment radio capabilities. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 receives, from a core network function, a request for radio capabilities of the user equipment. In various embodiments, the processor 202 determines the radio capabilities of the user equipment. In certain embodiments, the transmitter 210 transmits a response to the request for the radio capabilities of the user equipment.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

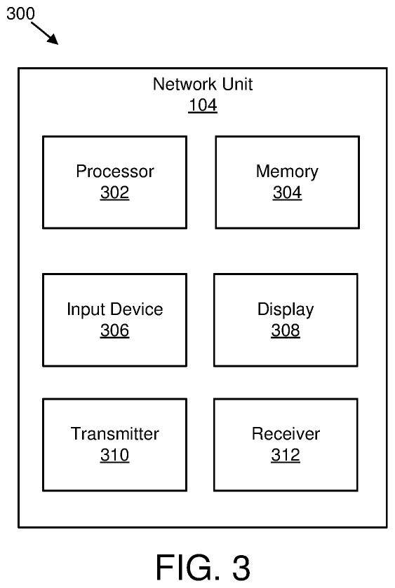

FIG. 3 depicts one embodiment of an apparatus 300 that may be used for user equipment radio capabilities. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 transmits a request for radio capabilities of a user equipment. In various embodiments, the receiver 312 receives a response to the request for the radio capabilities of the user equipment. In certain embodiments, the processor 302 determines at least one allowed network slice, at least one rejected network slice, or a combination thereof based on the radio capabilities of the user equipment. In some embodiments, the transmitter 310 transmits a configuration message to the user equipment, and the configuration message indicates the at least one allowed network slice, the at least one rejected network slice, or the combination thereof.

In certain embodiments, a network slice deployed in a network may span through a radio access network (“RAN”) and a core network (“CN”). In some embodiments, a network slice may be deployed on any cell or frequency band that would fulfil service requirements for the applications running on the network slice.

In various embodiments, with the evolution of fifth generation (“5G”) and, especially non-public networks (“NPNs”), some network slices may be deployed in a single or limited set of frequency bands. In such embodiments, networks may have network slices operating in any available frequency, but there may be network slices operating in a single or limited set of frequency bands.

In certain embodiments, some slices may be available only in part of a network. In some embodiments, next generation (“NG”) radio access network (“RAN”) (“NG-RAN”) supported single (“S”) network slice selection assistant information (“NSSAI”) (“S-NSSAI”) is configured by an operations, administration, and maintenance (“OAM”) device. In such embodiments, awareness in the NG-RAN of the slices supported in the cells of its neighbors may be beneficial for inter-frequency mobility in a connected mode. The slice availability does not change within a user equipment (“UE”) registration area.

In various embodiments, a RAN informs a core network (e.g., access and mobility management functions (“AMF”) to which the RAN has N2 transport association) about the available network slices in the RAN.

In certain embodiments, if a core network (e.g., AMF or network slice selection function (“NSSF”)) discovers that a UE can be served by more than one network slice (e.g., available network slices) operating in different frequency bands, the AMF may decide whether the UE can use the network slices simultaneously. In other words, the AMF needs to decide whether the available network slices are compatible for the UE so that the AMF can construct the allowed network slices (e.g., allowed NSSAI). This may be required for all S-NSSAIs in allowed NSSAI to be used simultaneously and in a whole registration area.

In some embodiments, appropriate matching of network slices in a serving network may be made. In such embodiments, a subscribed network slice may be deployed to operate in a specific frequency band that may not be available in a whole public land mobile network (“PLMN”) coverage. Moreover, there may be other possible network slices operating in different frequency bands. For example, the UE is subscribed to network slice #1 operating at FB #1. In some scenarios (e.g., roaming or in certain areas in the serving PLMN), the slice #1 may not be available and the network may map the service to slice #2 operating in FB #2 (e.g., high frequencies such as mm-wave or frequency range 2 (“FR2”)) or to slice #3 operating in FB #3 (e.g., mid-band frequencies such as 3-5 GHz). For the network to decide whether to use slice #2 or slice #3 for this UE, it is required that the network knows the UE radio capabilities (e.g., supported frequency blocks (“FBs”)—whether FB #2 or FB #3 or both are supported).

In various embodiments, multiple slices may be used in specific FBs. In such embodiments, if a UE is subscribed and requests to use simultaneously at least 2 network slices which are deployed in different FBs, a network (e.g., AMF or NSSF) may need to know the UE radio capabilities to determine whether the UE can be allowed to use the requested slices simultaneously.

In certain embodiments, a 5G core network (“5GC”) (e.g., AMF and/or NSSF) may be used to determine allowed network slices (e.g., allowed NSSAI) that cannot be used simultaneously by a UE.

In some embodiments, it may be determined how to let a 5GC (e.g., AMF and/or NSSF) know about a UE radio capability (e.g., frequency bands, band combination, carrier aggregation (“CA”), dual connectivity (“DC”)) to determine allowed NSSAI for the UE in a current registration area.

As used herein, the term “available network slices” may be used to describe that network slices are available in a current registration area for a UE and these available network slices correspond to the UE's subscribed network slices, or may be used to describe a subset of the subscribed network slices which are supported in the current registration area. Moreover, the term “allowed network slices” is used to describe that network slices are compatible to be used simultaneously by a UE in a current registration area. Further, allowed network slices are denoted as “allowed NSSAI.” As may be appreciated, the allowed network slices are equal to the available network slices or are a subset of the available network slices.

In various embodiments, it may be assumed that a core network (e.g., AMF and/or NSSF) is aware of an operating frequency band (“FB”) (e.g., a preferred operating FB) of network slices served by a current AMF. For example, an AMF and/or an NSSF are configured with information as follows: 1) S-NSSAI #1 operates in any available FB; 2) S-NSSAI #2 operates in FB2; and 3) S-NSSAI #3 operates in FB3 and FB4. In such embodiments, the radio access network (“RAN”) has indicated to the AMF that S-NSSAI #2 and S-NSSAI #3 are supported in the same tracking area TA #X. Moreover, the UE requests to register the network and the network (e.g., AMF and/or the NSSF) determine that network slices S-NSSAI #2 and S-NSSAI #3 may be assigned to the UE (e.g., the network slices S-NSSAI #2 and S-NSSAI #3 are available network slices to the UE). Because the AMF and/or an NSSF is aware that the S-NSSAI #2 and S-NSSAI #3 operate in different frequency bands, the AMF determines whether both slices S-NSSAI #2 and S-NSSAI #3 are compatible for the UE (e.g., whether S-NSSAI #2 and S-NSSAI #3 may be included in the allowed NSSAI for the UE).

In certain embodiments, during a procedure in an AMF requiring a determination of allowed NSSAI or rejected NSSAI, the AMF determines that UE radio capabilities are required to determine the allowed slices for the UE (e.g., allowed NSSAI). In such embodiments, the procedure in the AMF may be a registration procedure or UE configuration update (“UCU”) procedure due to a change of a set of network slices for the UE. As used herein, a set of network slices may refer to allowed network slices determined by an AMF and/or NSSF and based on this set, the AMF may decide to send a request for UE radio capabilities. The AMF request the UE radio capability in one of the following ways: 1) the AMF requests information from the NG-RAN (e.g., UE capability match request procedure) about the UE radio capabilities related to available network slices for the UE—for example, the AMF may include in a message to the RAN the one or more frequency bands capability (e.g., ‘requested FB [FB2, FB3, FB4]’); and 2) the AMF queries the UE via a non-access stratum (“NAS”) layer to request information about the radio capabilities of the UE (e.g., for a list of one or more FBs).

In some embodiments, a UE radio capabilities relevant to available S-NSSAIs for the UE may be the UE radio capabilities to support the frequency bands where these allowable S-NSSAIs operate (e.g., FB2, FB3 and FB4).

In various embodiments, a part of UE radio capabilities relevant to a determination of allowed NSSAI in an AMF and/or NSSF may be called “relevant radio capabilities.” The relevant radio capabilities provided to the AMF (e.g., by the NG-RAN or by the UE) may include at least one of the following parameters: 1) supported requested FBs [FB2=yes/no, FB3=yes/no, FB4=yes/no]; and/or 2) supported band combinations of requested FBs [FB2+FB3=yes/no, FB2+FB4=yes/no, FB3+FB4=yes/no, FB2+FB3+FB4=yes/no]—in addition to the band combinations, a RAN node may indicate for each combination whether it is supported as carrier aggregation (“CA”), or as dual connectivity (“DC”). Although the configuration for CA or DC is in the authority of RAN, the AMF may take this into consideration when determining the allowed NSSAI.

In certain embodiments, if an AMF determine that either: A) an S-NSSAI cannot be allowed due to the particular slice deployment in frequency bands not supported by the UE; or B) some of the available S-NSSAIs operate in FBs which are incompatible for the UE, the AMF may reject the S-NSSAI with an appropriate cause to indicate network slice incapability with the S-NSSAIs in the allowed NSSAI due to frequency incompatibility.

It should be noted that as used herein, the terms requested NSSAI, allowed NSSAI, or rejected NSSAI are according to a third generation partnership program (“3GPP”) specification and include one or more values of single S-NSSAIs.

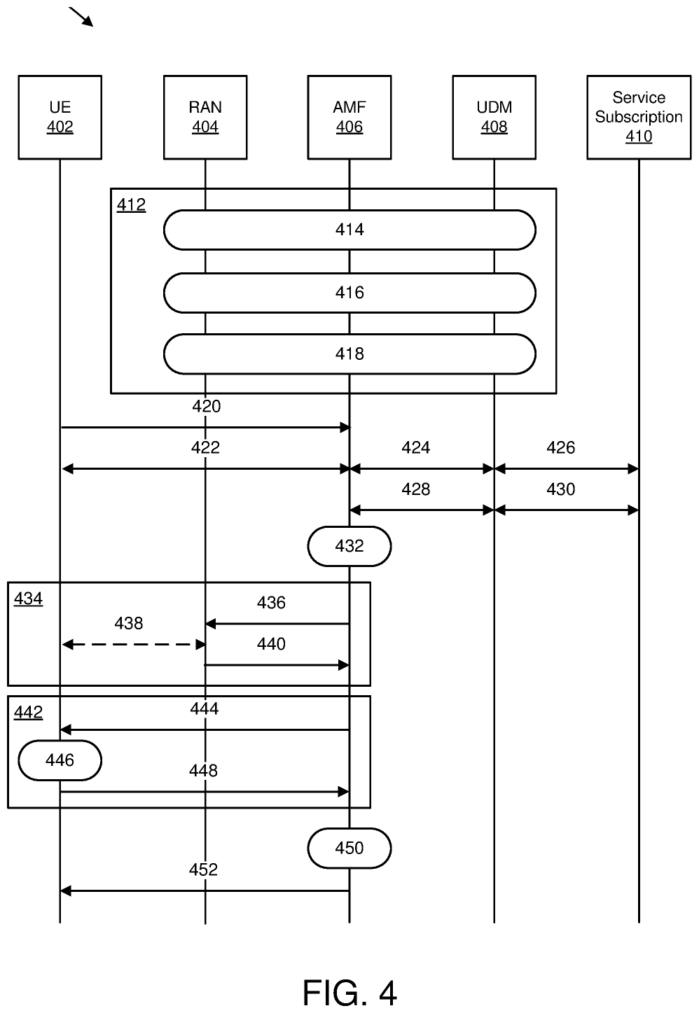

FIG. 4 is a network communications diagram illustrating one embodiment of a system 400 for determining allowed NSSAI and/or rejected NSSAI based on UE radio capabilities. The system 400 includes a UE 402, a RAN 404 (e.g., access network “AN”), an AMF 406 (e.g., AMF and/or NSSF), a UDM 408 (e.g., UDM and/or UDR), and a service subscription 410. As may be appreciated, each of the communications made in the system 400 may include one or more messages.

In a first communication 412 transmitted between the RAN 404, the AMF 406, and the UDM 408, the system 400 may deploy a first network slice 414 (S-NSSAI #1) (e.g., in FB-1), a second network slice 416 (S-NSSAI #2) (e.g., in FB-2), and a third network slice 418 (S-NSSAI #3) (e.g., in FB-3).

In a second communication 420 transmitted from the UE 402 to the AMF 408, the UE 402 initiates a registration procedure and sends a registration request message to the AMF 408 containing a UE identifier (“ID”) and/or a requested NSSAI. The registration procedure may be an initial registration, a mobility and/or update registration, and/or a periodic registration. For example, the requested NSSAI may contain the values S-NSSAI #1 and S-NSSAI #2. The UE 402 may be a subscriber of the serving network (e.g., from the serving PLMN or NPN), or the UE may be a subscriber of the external network shown as home public land mobile network (“HPLMN”) or service provider. In some embodiments, the UE credentials and subscription data may be stored in the serving PLMN, the NPN, in the HPLMN, and/or in the service provider.

In a third communication 422 transmitted between the UE 402 and the AMF 406, in a fourth communication 424 transmitted between the AMF 406 and the UDM 408, and in a fifth communication 426 transmitted between the UDM 408 and the service subscription 410, the AMF 406 initiates a primary authentication and authorization (“AA”) procedure for the UE 402. It is assumed that the primary AA procedure is completed successfully, and the AMF 406 receives the UE 402 credentials and/or keys for further non-access stratum (“NAS”) and access stratum (“AS”) security setup.

In a sixth communication 428 transmitted between the AMF 406 and the UDM 408 and in a seventh communication 430 transmitted between the UDM 408 and the service subscription 410, the AMF 406 retrieves the UE subscription. The subscription data contains a list of subscribed network slice identified by S-NSSAI #A and S-NSSAI #B, known as S-NSSAI values of the HPLMN or subscribed values.

The AMF 406 determines 432 that the UE's subscribed network slice (e.g., S-NSSAI #A and S-NSSAI #B) may be served in the current area by a set of available network slices. The available network slices are either configured in the AMF 406 by an OAM system (e.g., as part of the network configuration), or announced by the RAN 404 to the AMF 406 during the setup of an N2 transport network layer association (“TNLA”) between the RAN 404 and the AMF 406. The available network slices may have: 1) the same S-NSSAI value as subscribed network slices (e.g., mostly in the home network, home PLMN); or 2) different S-NSSAI values from the S-NSSAI values in the subscribed network slices. In one example, it may be assumed that 5-NSSAI #A and S-NSSAI #B may be mapped to other S-NSSAIs available in the area as shown here: 1) S-NSSAI #A maps to S-NSSAI #2; and S-NSSAI #B maps to S-NSSAI #3.

The AMF 406 assesses that the available network slices for the UE 402 are operating in different specific frequency bands. Based on this, the AMF 406 decides to query the relevant UE radio capabilities to determine whether the available network slices are compatible (e.g., may be used simultaneously or may be assigned as allowed NSSAI) for the UE 402. It should be noted that the AMF 406 does not need to know the full UE 402 radio capabilities, but merely the relevant UE 402 radio capabilities relevant to determine the allowed NSSAI. The UE 402 radio capabilities relevant to determine the allowed NSSAI from the set of available network slices are described as “relevant radio capabilities” and may be one of: 1) frequency band capability, including supported frequency bands, where the potentially allowable network slices operate, and the combination of frequency bands; and/or 2) other radio capabilities related to the network slice type (e.g., slice selection type (“SST”)) or to service requirements used for the deployment (e.g., instantiation) of the available network slices. For example, if the available network slice type is ultra-reliable low-latency communication (“URLLC”) and the UE 402 does not have the required radio capability for the URLLC service, the AMF 406 may decide to omit the inclusion of the URLLC network slice in the allowed NSSAI. For example, the related UE 402 radio capability may be a certain level of multiple input multiple output (“MIMO”) capability or bandwidth capability.

In one example, if available network slices S-NSSAI #2 operate in FB2 and S-NSSAI #3 operates in [FB3 and FB4], the AMF 406 determines to request UE 402 radio capabilities relevant to FB2, FB3, and FB4.

A first embodiment 434 includes steps 436, 438, and 440. Specifically, in an eighth communication 436 transmitted from the AMF 406 to the RAN 404, the AMF 404 requests information from the RAN 404 (e.g., NG-RAN) about the relevant UE radio capabilities. For example, the AMF 406 may use the existing signaling procedure UE capability match request procedure, or a new signaling procedure communicated between the AMF 406 and the RAN 404 may be used (e.g., a signaling exchange dedicated to a UE radio capability query relevant to a CN, specifically to the AMF 406). The AMF 406 may indicate exactly which relevant UE radio capabilities are required (e.g., one or more frequency bands and/or combinations of frequency bands supported).

In one example, the AMF 406 may send an N2 message (e.g., NG access point (“AP”) (“NGAP”) UE capability request message) indicating a list of requested FBs [FB2, FB3, FB4] and FB combinations.

In a ninth communication 438 optionally transmitted between the UE 402 and the RAN 404, the RAN 404 may perform a radio capability (“RC”) query from the UE 402 if the RAN 404 does not store the UE 402 radio capability.

In a tenth communication 440 transmitted from the RAN 404 to the AMF 406, the RAN 404 replies to the request from step 436. The RAN 404 processes and determines which UE 402 radio capability to report to the CN (e.g., AMF 406).

For example, the RAN 404 may send a UE capability reply message including a list of FBs [FB2=1, FB3=1, FB4=1], and FB combinations [FB2+FB3=0, FB2+FB4=0]). In this example the “0” means “no” or “non-support,” and “1” means “yes” or “support.” Any other flag or indication may be used to express “support” or “non-support” of the requested UE radio capability. Further information may be sent from the RAN 404 to the AMF 406 and may be described in “the radio capabilities provided to the AMF”—a high-level principle.

A second embodiment 442 includes steps 444, 446, and 448. Specifically, in an eleventh communication 444 transmitted from the AMF 406 to the UE 402, the AMF 406 sends a radio capability request to the UE 402 via an NAS layer. This may be done using a new NAS procedure. For example, the AMF 406 may send an N1 message UE capability request including parameters identifying which type of capabilities are required. This message may be similar to the message from step 436. In one example, the AMF 406 may include a list of requested FBs [FB2, FB3, FB4] and/or FB combinations.

The AMF 406 should not initiate an N1 connection release procedure while the UE 402 capability request exchange is ongoing. The AMF 406 may re-send the UE capability request message if no reply is received within an internally configured retransmission time.

Internally to the UE 402, the NAS layer queries 446 the AS layer about the requested radio capabilities. In one example, the NAS layer may query the AS layer about the list of supported FBs and corresponding FB combinations.

In a twelfth communication 448 transmitted from the UE 402 to the AMF 406, the UE 402 sends a reply to step 444 (e.g., the UE 402 sends an NAS message UE 402 capability reply including requested radio capabilities). The format or structure of the UE 402 capability reply message may be similar to the UE capability reply message described in step 440.

The AMF 406 determines 450 the S-NSSAIs to be included in the allowed NSSAI and/or in the rejected NSSAI based on UE 402 radio capabilities received in step 440 or in step 448.

The FB combinations supported may mean that the UE 402 supports CA or DC for the requested FBs. If a requested FB combination is supported, the AMF 406 may determine that the UE 402 is able to use the requested FBs simultaneously. In such an example, the AMF 406 determines that the UE 402 simultaneously uses the network slices corresponding to the FBs (e.g., the network slices are compatible with the UE 402). It should be noted that network slice compatibility is indicated with respect to a relevant radio capability for the particular UE 402.

For example, based on the received information in step 440 (e.g., list of FBs [FB2=1, FB3=1, FB4=1], and FB combinations [FB2+FB3=0, FB2+FB4=0]) and/or carrier aggregation or dual connectivity per band combination, the AMF 406 determines that the UE 402 may be allowed to use any single S-NSSAI #2 or NSSAI #3 in this registration area, but the UE is not able to use simultaneously S-NSSAI #2 and NSSAI #3. Further information which may be sent from the UE 402 to the AMF 406 is described in “the radio capabilities provided to the AMF”. Based on the received radio capabilities and additional configuration in the AMF 406 or NSSF, the AMF 406 may decide to send the S-NSSAI #2 in the allowed NSSAI and to reject S-NSSAI #3.

In a thirteenth communication 452 transmitted from the AMF 406 to the UE 402, the AMF 406 sends an NAS registration accept message to the UE 402 encapsulated in an N2 and/or an NGAP message to the RAN 404. The registration accept message may contain allowed NSSAI and rejected NSSAI. A new cause value may be introduced for the rejected S-NSSAI (e.g., part of the rejected NSSAI) to indicate to the UE 402 the reason for rejection. For example, a new reject cause may be “rejected due to FB incapability”. The UE 402 determines, based on the reject cause, that the network slices in the allowed NSSAI and the network slices in the rejected NSSAI are not compatible to be used simultaneously due to radio incompatibility for the UE 402.

For example, if the AMF 406 determines that the S-NSSAI #2 and S-NSSAI #3 cannot be supported simultaneously in the UE 402, the AMF 406 determines that one network slice (e.g., S-NSSAI #2 mapped to S-NSSAI #A) is sent in allowed NSSAI, whereas another network slice (e.g., S-NSSAI #3 mapped to S-NSSAI #B) is rejected. The UE 402 may use S-NSSAI #2 mapped to S-NSSAI #A in the registration area. If the UE 402 wants to used S-NSSAI #B, the UE 402 determines, based on the reject cause, to initiate a new registration procedure and includes the S-NSSAI #B only in the requested NSSAI in the registration request message, but does not include the S-NSSAI #A.

It should be noted that the embodiments described in FIG. 4 are not limited to the specified configuration (e.g., using multiple slices in different FBs). The embodiments of FIG. 4 may be to other configurations (e.g., selecting appropriate matching serving slice) where the UE's subscribed network slices S-NSSAI #A and S-NSSAI #B are not available in the current area, but multiple other network slices are available (e.g., S-NSSAI #2, S-NSSAI #3, S-NSSAI #4, or 5-NSSAI #5). For the AMF 406 to decide which S-NSSAIs to use in the allowed NSSAI, the AMF 406 may determine (similar to step 432 in FIG. 4) to request the relevant UE 402 radio capabilities using either the first embodiment 434 or the second embodiment 442. After the AMF 406 receives the relevant UE 402 radio capabilities, the AMF 406 determines which of the available S-NSSAI #2 and/or S-NSSAI #3 to map to the subscribed S-NSSAI #A; and which of the available S-NSSAI #4 and/or S-NSSAI #5 to map to the subscribed S-NSSAI #B. The AMF 406 may map to the subscribed S-NSSAIs only available S-NSSAIs which operate in FBs supported by the UE 402. The AMF 406 may determine (e.g., similar to step 450 in FIG. 4) which S-NSSAIs are in the allowed NSSAI based on the received relevant UE 402 radio capabilities.

In one example, it may be assumed that S-NSSAI #2 operates in FB #2, S-NSSAI #3 operates in [FB #3, FB #4], S-NSSAI #4 operates in FB #4, and S-NSSAI #5 operates in FB #5. The AMF 406 may receive the following UE 402 radio capability: supported FBs [FB2=1, FB3=0, FB4=1, FB5=0], and FB combinations [FB2+FB4=1]. The AMF 406 may determine to assign the following mapping in the allowed NSSAI: S-NSSAI #A maps to S-NSSAI #2, and S-NSSAI #B maps to S-NSSAI #4. Because both S-NSSAI #2 and S-NSSAI #4 operate in the FB #2 and FB #4 which are supported by the UE 402, and both FB #2 and FB #4 are compatible for the UE 402.

Benefits of embodiments described herein may be that the AMF 406 is able to determine (e.g., based on the radio capabilities for a particular UE 402) whether the available network slices (e.g., identified by S-NSSAIs) may be used simultaneously and whether they are compatible for the UE 402. There may be only one interaction between the AMF 406 and the RAN 404 needed to retrieve relevant UE 402 radio capabilities. The AMF 406 may determine that only the compatible network slices may be sent as allowed network slices (e.g., allowed NSSAI) to the UE 402. It should be noted that network slice compatibility is meant with respect to the radio capability for a particular UE 402.

In various embodiments, besides UE radio capabilities related to FB support, a core network (e.g., AMF) may determine to request additional or different UE radio capabilities. These additional (or different) UE radio capabilities may indicate to the AMF whether a given type of network slice is supported. The AMF takes the additional UE radio capabilities into account when determining the allowed NSSAI and rejected NSSAI. For example, the MIMO support or the support of frequency bandwidth may indicate to a CN (e.g., AMF) whether a URLLC type of network slice is supported.

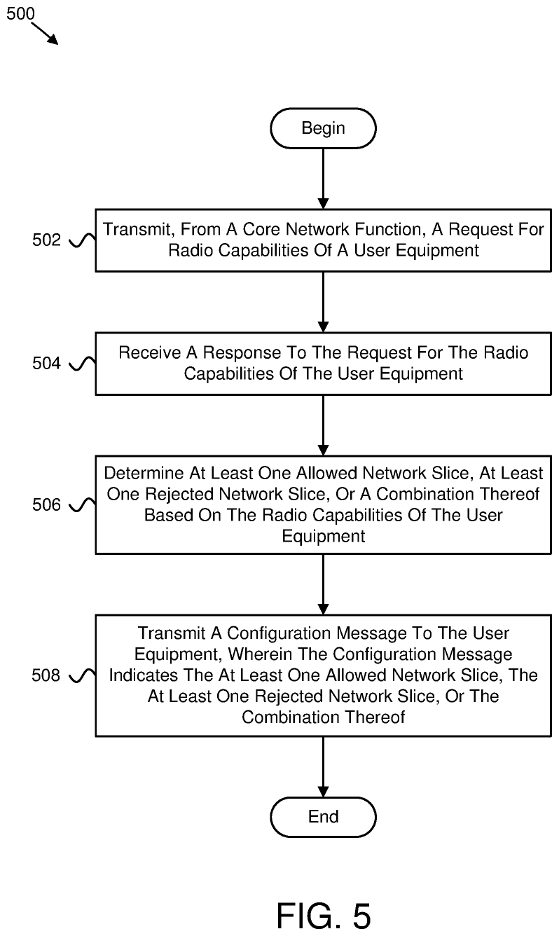

FIG. 5 is a flow chart diagram illustrating one embodiment of a method 500 for user equipment radio capabilities. In some embodiments, the method 500 is performed by an apparatus, such as the network unit 104. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes transmitting 502, from a core network function, a request for radio capabilities of a user equipment. In some embodiments, the method 500 includes receiving 504 a response to the request for the radio capabilities of the user equipment. In certain embodiments, the method 500 includes determining 506 at least one allowed network slice, at least one rejected network slice, or a combination thereof based on the radio capabilities of the user equipment. In various embodiments, the method 500 includes transmitting 508 a configuration message to the user equipment, wherein the configuration message indicates the at least one allowed network slice, the at least one rejected network slice, or the combination thereof.

In certain embodiments, the core network function comprises an access and mobility management function, a network slice selection function, or a combination thereof. In some embodiments, the method 500 further comprises receiving a registration request message from the user equipment, wherein the registration request message triggers transmission of the request for the radio capabilities of the user equipment. In various embodiments, the method 500 further comprises receiving an indication of a change or determining a change in a set of network slices for the user equipment, wherein the indication triggers transmission of the request for the radio capabilities of the user equipment.

In one embodiment, the method 500 further comprises determining that the radio capabilities of the user equipment are required based on the set of network slices operating in specific frequency bands and prior to transmission of the request for the radio capabilities of the user equipment. In certain embodiments, transmitting the request for the radio capabilities of the user equipment comprises transmitting the request to a radio access network. In some embodiments, transmitting the request for the radio capabilities of the user equipment comprises transmitting the request to the user equipment.

In various embodiments, transmitting the request to the user equipment comprises transmitting the request to the user equipment via a non-access stratum protocol layer. In one embodiment, the radio capabilities of the user equipment comprise a list of frequency bands supported, a list of frequency band combinations supported, or a combination thereof. In certain embodiments, the configuration message comprises an indication indicating the at least one rejected network slice and associated cause information indicating that the rejection is due to a frequency incapability.

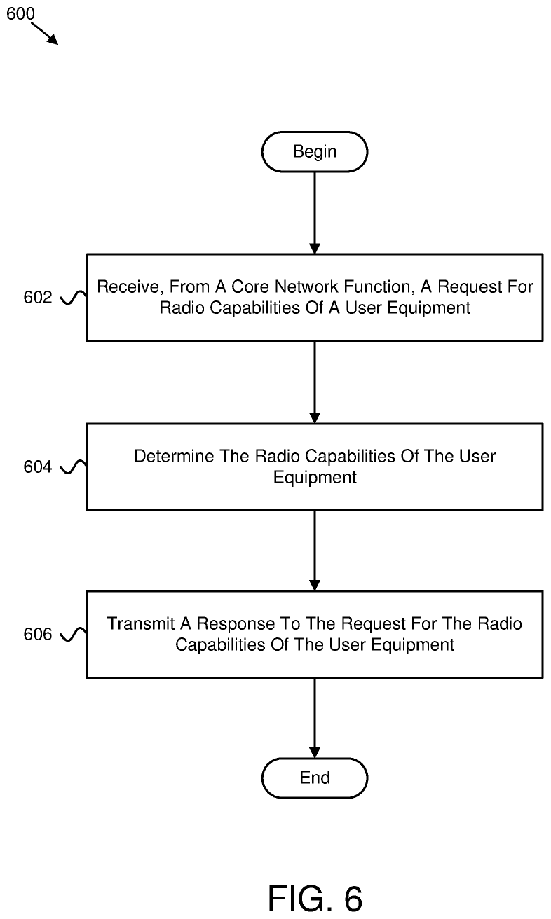

FIG. 6 is a flow chart diagram illustrating another embodiment of a method 600 for user equipment radio capabilities. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes receiving 602, from a core network function, a request for radio capabilities of a user equipment. In some embodiments, the method 600 includes determining 604 the radio capabilities of the user equipment. In certain embodiments, the method 600 includes transmitting 606 a response to the request for the radio capabilities of the user equipment.

In certain embodiments, receiving the request for the radio capabilities of the user equipment comprises receiving the request for the radio capabilities of the user equipment at a radio access network entity. In some embodiments, determining the radio capabilities of the user equipment comprises extracting the radio capabilities of the user equipment from a full set of available radio capabilities.

In various embodiments, receiving the request for the radio capabilities of the user equipment comprises receiving the request for the radio capabilities of the user equipment at the user equipment via a non-access stratum protocol layer. In one embodiment, determining the radio capabilities of the user equipment comprises transmitting a request from a non-access stratum layer to an access stratum layer requesting the radio capabilities.

In certain embodiments, the radio capabilities of the user equipment comprise a list of frequency bands supported, a list of frequency band combinations supported, or a combination thereof. In some embodiments, the method 600 further comprises receiving a configuration message, wherein the configuration message indicates at least one allowed network slice, at least one rejected network slice, or a combination thereof. In various embodiments, the configuration message comprises an indication indicating the at least one rejected network slice and associated cause information indicating that the rejection is due to a frequency incapability.

In one embodiment, a method comprises: transmitting, from a core network function, a request for radio capabilities of a user equipment; receiving a response to the request for the radio capabilities of the user equipment; determining at least one allowed network slice, at least one rejected network slice, or a combination thereof based on the radio capabilities of the user equipment; and transmitting a configuration message to the user equipment, wherein the configuration message indicates the at least one allowed network slice, the at least one rejected network slice, or the combination thereof.

In certain embodiments, the core network function comprises an access and mobility management function, a network slice selection function, or a combination thereof.

In some embodiments, the method further comprises receiving a registration request message from the user equipment, wherein the registration request message triggers transmission of the request for the radio capabilities of the user equipment.

In various embodiments, the method further comprises receiving an indication of a change or determining a change in a set of network slices for the user equipment, wherein the indication triggers transmission of the request for the radio capabilities of the user equipment.

In one embodiment, the method further comprises determining that the radio capabilities of the user equipment are required based on the set of network slices operating in specific frequency bands and prior to transmission of the request for the radio capabilities of the user equipment.

In certain embodiments, transmitting the request for the radio capabilities of the user equipment comprises transmitting the request to a radio access network.

In some embodiments, transmitting the request for the radio capabilities of the user equipment comprises transmitting the request to the user equipment.

In various embodiments, transmitting the request to the user equipment comprises transmitting the request to the user equipment via a non-access stratum protocol layer.

In one embodiment, the radio capabilities of the user equipment comprise a list of frequency bands supported, a list of frequency band combinations supported, or a combination thereof.

In certain embodiments, the configuration message comprises an indication indicating the at least one rejected network slice and associated cause information indicating that the rejection is due to a frequency incapability.

In one embodiment, an apparatus comprises a core network function. The apparatus further comprises: a transmitter that transmits a request for radio capabilities of a user equipment; a receiver that receives a response to the request for the radio capabilities of the user equipment; and a processor that determines at least one allowed network slice, at least one rejected network slice, or a combination thereof based on the radio capabilities of the user equipment; wherein the transmitter transmits a configuration message to the user equipment, and the configuration message indicates the at least one allowed network slice, the at least one rejected network slice, or the combination thereof.

In certain embodiments, the core network function comprises an access and mobility management function, a network slice selection function, or a combination thereof.

In some embodiments, the receiver receives a registration request message from the user equipment, and the registration request message triggers transmission of the request for the radio capabilities of the user equipment.

In various embodiments, the receiver receives an indication of a change or determining a change in a set of network slices for the user equipment, and the indication triggers transmission of the request for the radio capabilities of the user equipment.

In one embodiment, the processor determines that the radio capabilities of the user equipment are required based on the set of network slices operating in specific frequency bands and prior to transmission of the request for the radio capabilities of the user equipment.

In certain embodiments, the transmitter transmitting the request for the radio capabilities of the user equipment comprises the transmitter transmitting the request to a radio access network.

In some embodiments, the transmitter transmitting the request for the radio capabilities of the user equipment comprises the transmitter transmitting the request to the user equipment.

In various embodiments, the transmitter transmitting the request to the user equipment comprises the transmitter transmitting the request to the user equipment via a non-access stratum protocol layer.

In one embodiment, the radio capabilities of the user equipment comprise a list of frequency bands supported, a list of frequency band combinations supported, or a combination thereof.

In certain embodiments, the configuration message comprises an indication indicating the at least one rejected network slice and associated cause information indicating that the rejection is due to a frequency incapability.

In one embodiment, a method comprises: receiving, from a core network function, a request for radio capabilities of a user equipment; determining the radio capabilities of the user equipment; and transmitting a response to the request for the radio capabilities of the user equipment.

In certain embodiments, receiving the request for the radio capabilities of the user equipment comprises receiving the request for the radio capabilities of the user equipment at a radio access network entity.

In some embodiments, determining the radio capabilities of the user equipment comprises extracting the radio capabilities of the user equipment from a full set of available radio capabilities.

In various embodiments, receiving the request for the radio capabilities of the user equipment comprises receiving the request for the radio capabilities of the user equipment at the user equipment via a non-access stratum protocol layer.

In one embodiment, determining the radio capabilities of the user equipment comprises transmitting a request from a non-access stratum layer to an access stratum layer requesting the radio capabilities.

In certain embodiments, the radio capabilities of the user equipment comprise a list of frequency bands supported, a list of frequency band combinations supported, or a combination thereof.

In some embodiments, the method further comprises receiving a configuration message, wherein the configuration message indicates at least one allowed network slice, at least one rejected network slice, or a combination thereof.

In various embodiments, the configuration message comprises an indication indicating the at least one rejected network slice and associated cause information indicating that the rejection is due to a frequency incapability.

In one embodiment, an apparatus comprises a user equipment. The apparatus further comprises: a receiver that receives, from a core network function, a request for radio capabilities of the user equipment; a processor that determines the radio capabilities of the user equipment; and a transmitter that transmits a response to the request for the radio capabilities of the user equipment.

In certain embodiments, the receiver receiving the request for the radio capabilities of the user equipment comprises the receiver receiving the request for the radio capabilities of the user equipment at a radio access network entity.

In some embodiments, the processor determining the radio capabilities of the user equipment comprises the processor extracting the radio capabilities of the user equipment from a full set of available radio capabilities.

In various embodiments, the receiver receiving the request for the radio capabilities of the user equipment comprises the receiver receiving the request for the radio capabilities of the user equipment at the user equipment via a non-access stratum protocol layer.

In one embodiment, the processor determining the radio capabilities of the user equipment comprises the transmitter transmitting a request from a non-access stratum layer to an access stratum layer requesting the radio capabilities.

In certain embodiments, the radio capabilities of the user equipment comprise a list of frequency bands supported, a list of frequency band combinations supported, or a combination thereof.

In some embodiments, the receiver receives a configuration message, and the configuration message indicates at least one allowed network slice, at least one rejected network slice, or a combination thereof.

In various embodiments, the configuration message comprises an indication indicating the at least one rejected network slice and associated cause information indicating that the rejection is due to a frequency incapability.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising a core network function, the apparatus further comprising:
a transmitter that transmits a request for radio capabilities of a user equipment;
a receiver that receives a response to the request for the radio capabilities of the user equipment; and
a processor that determines at least one allowed network slice, at least one rejected network slice, or a combination thereof based on the radio capabilities of the user equipment;
wherein the transmitter transmits a configuration message to the user equipment, and the configuration message indicates the at least one allowed network slice, the at least one rejected network slice, or the combination thereof.

2. The apparatus of claim 1, wherein the core network function comprises an access and mobility management function, a network slice selection function, or a combination thereof.

3. The apparatus of claim 1, wherein the receiver receives a registration request message from the user equipment, and the registration request message triggers transmission of the request for the radio capabilities of the user equipment.

4. The apparatus of claim 1, wherein the processor determines that the radio capabilities of the user equipment are required based on a set of network slices operating in specific frequency bands and prior to transmission of the request for the radio capabilities of the user equipment.

5. The apparatus of claim 1, wherein the transmitter transmitting the request for the radio capabilities of the user equipment comprises the transmitter transmitting the request to a radio access network.

6. The apparatus of claim 1, wherein the transmitter transmitting the request for the radio capabilities of the user equipment comprises the transmitter transmitting the request to the user equipment.

7. The apparatus of claim 6, wherein the transmitter transmitting the request to the user equipment comprises the transmitter transmitting the request to the user equipment via a non-access stratum protocol layer.

8. The apparatus of claim 1, wherein the radio capabilities of the user equipment comprise a list of frequency bands supported, a list of frequency band combinations supported, or a combination thereof.

9. The apparatus of claim 1, wherein the configuration message comprises an indication indicating the at least one rejected network slice and associated cause information indicating that the rejection is due to a frequency incapability.

10. An apparatus comprising a user equipment, the apparatus further comprising:
a receiver that receives, from a core network function, a request for radio capabilities of the user equipment;
a processor that determines the radio capabilities of the user equipment; and
a transmitter that transmits a response to the request for the radio capabilities of the user equipment.

11. The apparatus of claim 10, wherein the receiver receiving the request for the radio capabilities of the user equipment comprises the receiver receiving the request for the radio capabilities of the user equipment at a radio access network entity.

12. The apparatus of claim 10, wherein the processor determining the radio capabilities of the user equipment comprises the processor extracting the radio capabilities of the user equipment from a full set of available radio capabilities.

13. The apparatus of claim 10, wherein the receiver receiving the request for the radio capabilities of the user equipment comprises the receiver receiving the request for the radio capabilities of the user equipment at the user equipment via a non-access stratum protocol layer.

14. The apparatus of claim 10, wherein the processor determining the radio capabilities of the user equipment comprises the transmitter transmitting a request from a non-access stratum layer to an access stratum layer requesting the radio capabilities.

15. The apparatus of claim 10, wherein the radio capabilities of the user equipment comprise a list of frequency bands supported, a list of frequency band combinations supported, or a combination thereof.

16. A method at a core network function, the method comprising:
transmitting a request for radio capabilities of a user equipment;
receiving a response to the request for the radio capabilities of the user equipment;
determining at least one allowed network slice, at least one rejected network slice, or a combination thereof based on the radio capabilities of the user equipment; and
transmitting a configuration message to the user equipment, and the configuration message indicates the at least one allowed network slice, the at least one rejected network slice, or the combination thereof.

17. The method of claim 16, wherein the core network function comprises an access and mobility management function, a network slice selection function, or a combination thereof.

18. The method of claim 16, further comprising receiving a registration request message from the user equipment, wherein the registration request message triggers transmission of the request for the radio capabilities of the user equipment.

19. The method of claim 16, further comprising determining that the radio capabilities of the user equipment are required based on a set of network slices operating in specific frequency bands and prior to transmission of the request for the radio capabilities of the user equipment.

20. The method of claim 16, further comprising transmitting the request to a radio access network.
